(19) United States
(12) Patent Application Publication
(10) Pub. No.: US 2016/0171133 A1
(43) Pub. Date: Jun. 16, 2016

(54) Method for Performing a Test Run on a Test Bench

(71) Applicant: AVL LIST GMBH, Graz (AT)

(72) Inventors: Felix Pfister, Graz (AT); Clemens Reitze, Karlsruhe (DE)

(73) Assignee: AVL LIST GMBH, GRAZ (AT)

(21) Appl. No.: 14/907,975

(22) PCT Filed: Jul. 25, 2014
(86) PCT No.: PCT/EP2014/065996

§ 371 Date: Jan. 27, 2016

(30) Foreign Application Priority Data
Jul. 26, 2013 (AT) A 50472/2013

(51) Int. Cl. G06F 17/50

(52) U.S. Cl. CPC G06F 17/5009

(57) ABSTRACT

In order to be able to superimpose and compare measurement results from test runs in a substantially more effective, faster, and improved manner, a virtual track (A*-B*) is read from a data storage unit (4), wherein the virtual track (A*-B*) is stored as a sequence of geo-coordinates (P) and with corresponding, to the geo-coordinate (P) related data (D) of a vehicle (1*), a driver and/or surroundings of the vehicle (1*), and the virtual track (A*-B*) is used to carry out the test run of the virtual vehicle (1*), wherein measured data (M) on the virtual vehicle (1*) is detected and stored in relation to the geo-coordinate (P) during the test run.

The present invention relates to a method for carrying out a test run of a virtual vehicle on a test bench.

Test runs for bench testing of vehicles or components thereof, such as e.g. the drivetrain, engine, transmission, and the like, are presently derived in part from real test drives, in which a real vehicle is driven over a real test track while measured data is being collected, along with the surroundings of the road and the vehicle, such as traffic and the like, and specific events, such as road signs, traffic lights, crosswalks, and the like. GPS and other measuring techniques offer the ability to detect the road profile (incline, slope, curves, and the like), the vehicle surface (geometry, material properties, and the like), and even dynamic data about the vehicle (speed, acceleration, consumption, indicating data about combustion in an internal combustion engine, emissions, and the like), and the surroundings (traffic, crosswind, temperature, pressure, humidity, and the like). Driver behavior, such as e.g. acceleration and braking behaviors, can also be detected in a similar manner. From the detected data, a simulation is created, with which the test bench is controlled in order to virtually drive the detected test track, or one that is derived therefrom, on the test bench. This typically involves the creation of a one-dimensional profile of the form v=v(x) or v=v(t) (where v=speed, x=path or arc length of the road, and t=time), which characterizes the driven track and is then traced on the test bench. For example, a chassis test bench is controlled such that the vehicle, which is arranged thereon, drives the detected test track. The test track can also be graphically visualized in the simulation by means of graphic objects. Such a system is disclosed in, for example, EP 2 246 686 A1.

At the same time, during the test drives, it is also possible to record video or audio data about the driven track, the driver activities, or the vehicle and the surroundings thereof. WO 2009/083944 A1, for example, describes detecting measured data with sensors, which are arranged on a vehicle, wherein video of the driven track is also detected via a camera and stored. However, any further use of this video data is not dealt with therein.

The known prior art entails detecting, managing and depicting measured data detected during a test drive over a common time axis (i.e., time synchronized), a common one-dimensional path axis (i.e., path synchronized), or a crank angle signal (i.e., angle synchronized). This manner of processing, however, leads to a number of problems. Firstly, measured data on different test runs, even when based partially (in sections) on the same test track, may be hardly comparable, because it is almost impossible to find overlaps in data that is managed time synchronized (t), path synchronized (x) or angle synchronized. In addition, a test run that is derived from a real test drive is never completely identical to the real test drive, for example, because the driver cuts the curves differently in the virtual test drive. The result is that in the test run, there is necessarily always a temporal or spatial divergence in the measured data of the real test drive, or other virtual test drives, and in the measured data of the test run. This becomes more noticeable when the same track is driven with different driver profiles (driver characteristics). Such test runs are also not directly comparable. This leads to major difficulties in achieving comparable test runs and in comparison of the measured data.

It is therefore an object of the present invention to provide a method that makes it possible to establish measurement results from test runs in a substantially more effective, faster, and improved manner and to “superimpose” and compare the measurements results therefrom, in order to obtain meaningful results out of a test run.

This object is solved according to the invention by reading a virtual track from a data storage unit, wherein the virtual track is stored as a sequence of geo-coordinates and with corresponding, to geo-coordinate related data on a vehicle, a driver and/or surroundings of the vehicle, and by using the virtual track to carry out the test run of the virtual vehicle, wherein measured data of the virtual vehicle is detected and stored in relation to the geo-coordinates during the test run. By that, the conventional one-dimensional path-time profile used so far, with all the described disadvantages, is abandoned, by detecting and storing all data with reference to geo-coordinates. The virtual test track is now present as a three-dimensional trajectory, in the form of geo-coordinates and with stored data, which is used to carry out the test run, making it possible to retrieve and compare data and/or measured data from the test run directly via the geo-coordinate.

The virtual track for the test run can preferably be created by driving over a real track with a real vehicle, by detecting the geographic coordinates and data about the vehicle, the driver and/or the surroundings of the vehicle as the vehicle moves along the real track and to store everything as a chronological sequence with reference to the geo-coordinate. This enables, in particular, the automated creation of the virtual track as a chronological sequence of geo-coordinates, wherein the virtual track is very close to the real track.

Alternatively, the virtual track may also be detected from digital three-dimensional map data, wherein data about the vehicle, the driver and/or the surroundings of the vehicle can be added.

Especially advantageously, the test run—and in particular the variables that are relevant to the actors of the test bench, such as pressure, humidity, road slope, curvature, and the like—is driven as a sequence of stored geo-coordinates. This makes it possible for the test run to be generated directly from the virtual track, by tracing the stored geo-coordinates. Further data necessary for the test run can be easily extracted from the data file of the virtual track via the geographic coordinates. For this purpose, it may be provided that a speed that is stored in relation to the geo-coordinate or a stored time is used in order to control the virtual vehicle in the test run.

In order to carry out the test run, the virtual vehicle may be controlled by a virtual driver, on the basis of a driver model. This makes it possible that the same virtual track is driven differently on the basis of different driver models, and to produce different measured data that can also easily be compared via the geo-coordinates afterwards. Alternatively, the virtual vehicle for carrying out the test run may also be controlled by a real driver.

It is particularly advantageous if video data about the test track is additionally detected in the form of a sequence of video frames and if the video frame that corresponds to the respective geo-coordinate being determined and displayed during the test run on the test bench. In this manner, videos of the real drive can be easily played back on the test bench. Real videos are not yet used on the test bench to visualize a test run. This is partly because video data is very memory-intensive and cumbersome to manage and process (cutting, concatenation, timeline, and the like), and because it is difficult to synchronize the video data with the test run on the test bench. However, there is a desire for a more realistic visualization of the test runs on the test bench, which is now readily possible on the basis of the real videos and the management, controlling, and synchronizing of the video player, via geo-coordinates.

In the same manner, audio data about the test track can also be detected and stored with reference to the geo-coordinate, and the audio data that corresponds to the respective geo-coordinate can be played back during the test run on the test bench.

If data or measured data for respective geo-coordinates is retrieved and displayed during the test run, then it is also easy to make direct comparisons with already-existing data or measured data online during the carrying out of the test run.

Likewise, in the post-processing of the test run, data or measured data can be searched, identified, and compared via the geo-coordinate thereof, thus greatly simplifying the post-processing of the test run.

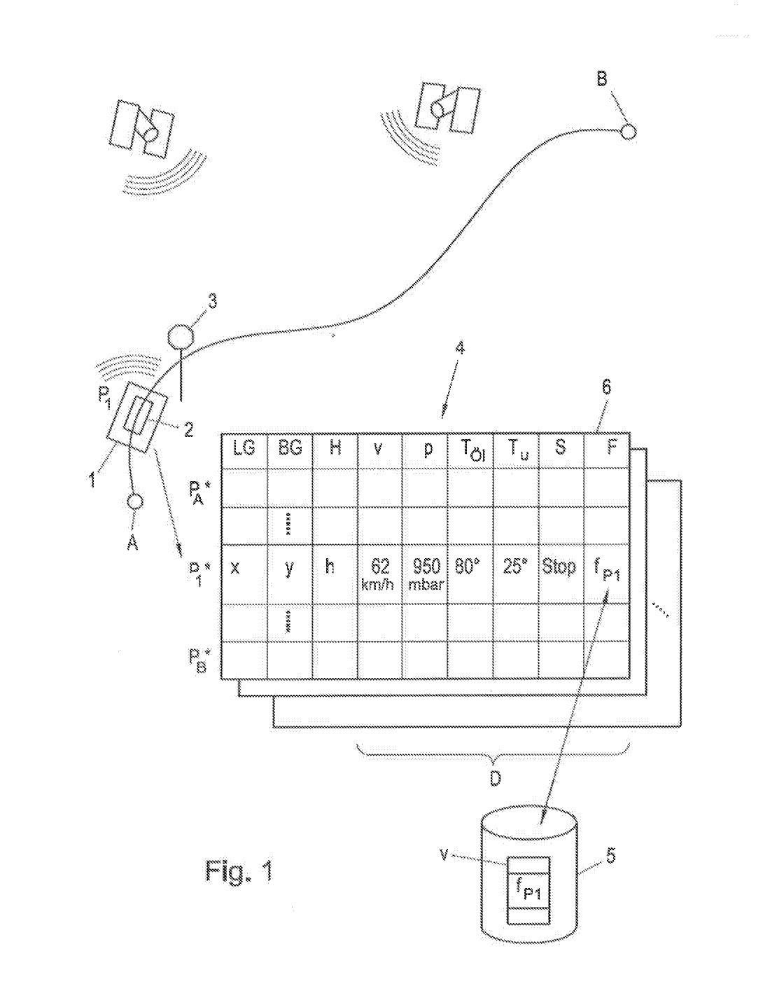

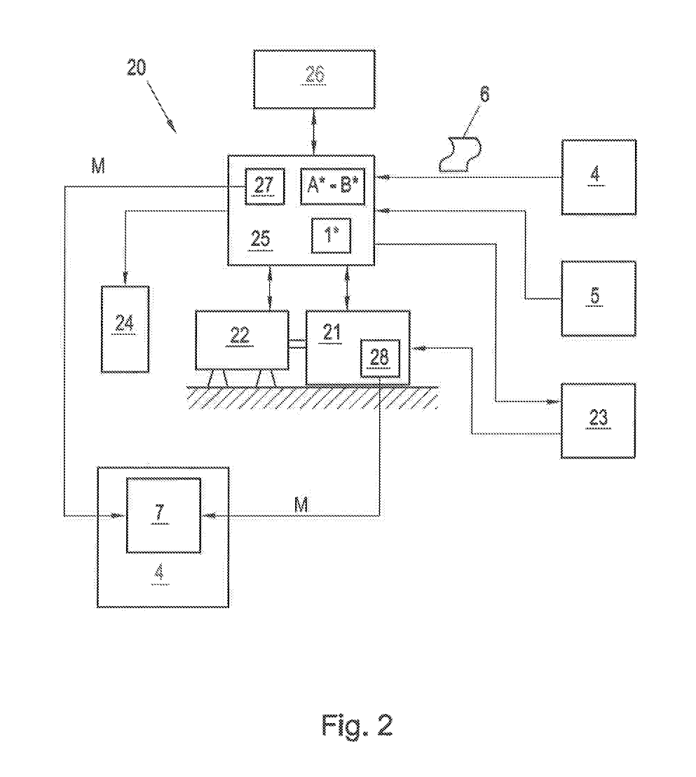

The present invention shall now be described in greater detail, with reference to FIGS. 1 and 2, which, by way of example, illustrate advantageous embodiments of the invention in a schematic and non-restrictive manner.

FIG. 1 illustrates the detection of a virtual track, and

FIG. 2 illustrates a test bench for carrying out a test run with a virtual vehicle.

As is indicated in FIG. 1, a vehicle 1 actually drives a certain track A-B in reality, in one possible embodiment of the invention. Sensors 2 are arranged on the vehicle 1, whereas there is provided at least one known device for determining the current time (or another monotonically increasing variable) and the current geographic position, e.g. the Global Positioning System (GPS) or Galileo, and at least one more sensor for detecting a parameter of the vehicle (speed, acceleration, fuel consumption, indicating data of the combustion of an internal combustion engine, emissions, the 3D orientation of the vehicle in space, or the like), of the driver (acceleration or braking behaviors, switching behaviors, overtaking behaviors, or the like), or the surroundings (video, audio, traffic, crosswind, temperature, pressure, humidity, road conditions, or the like). Such sensors 2 are well known and available in a variety of forms and types, and shall therefore not be described in further detail here. It is also conceivable that during the drive, more events, such as a road sign 3, a traffic light, cross-traffic, other road users, or the like, may be detected. The data D that is thus detected during the drive of the vehicle 1 is stored in a data storage unit 4 in reference to the geographic position. The virtual track A*-B*, which has been detected in this manner, or the data file 6 generated therefrom, can subsequently be further processed, for example, in order to add or modify data D, such as the road conditions (ice, potholes, road width, lane grooves, or the like), traffic signs, traffic lights, or the like, or in order to remove any unneeded data D.

Due to unavoidable measurement inaccuracies or possible post-processing, the recorded track A*-B* will not correspond exactly to the real track A-B, which is why it is referred to a virtual track A*-B* in the description, that is marked with “*”.

In further consequence, a geographic position is also referred to as geo-coordinate P, for the sake of simplicity. A Geo-coordinate P, in this sense, is a clear identification of any location on the Earth, e.g. in the form of the longitude, the latitude, and the altitude in the case of GPS.

In an alternative embodiment, a real track A-B can be extracted in the form of geo-coordinates P from available digital 3D maps to record a virtual track A*-B* therefrom, wherein the other variables, such as time and parameters of the vehicle or the surroundings, can either also be extracted from 3D map data (e.g. street signs) or can be added later.

The geo-coordinate P is detected, for example, according to a predetermined time pattern, e.g. every half second, in the form of the longitude LG, the latitude BG and the altitude H. In addition, the additionally detected data is respectively stored or added, e.g. the instantaneous speed v, the pressure p, the oil temperature T_{öl}, the outside temperature T_{U}, or any road signs S. Basically, any data of the vehicle 1, the driver and/or the surroundings (not all of which can be mentioned here) can be stored. It is crucial that the additional data is all also detected and stored with reference to a geo-coordinate P.

In addition, the drive of the vehicle 1 may be recorded as video V. Not only the surroundings can be recorded, but also, for example, components on the vehicle 1, such as the suspension or the brakes. For this purpose, the data storage unit 5 can store a reference F to the recorded video V for each of the geo-coordinate P, e.g. in the form of the video frame number f_{P1} or the video time for the respective geo-coordinate P. The recorded video V can be stored in a video storage unit 5. This is indicated in FIG. 1 for the geo-coordinate P₁*.

Videos V can be recorded and stored with reference to a geo-coordinate P even in the case of virtual tracks A*-B* derived from digital maps. Available videos V for the track A-B or parts thereof can be loaded and saved for this purpose. For example, a track could be driven in Google Earth® and the generated video file would then be used as the video for the virtual track A*-B*.

In this manner, data files of different tracks and under different conditions, e.g. different seasons, different weather conditions, different drivers, different traffic, and the like, with reference to geo-coordinates P can be generated and stored, as is indicated in FIG. 1. The data files 6 generated in this manner can then be accessed online (even in real time) or offline.

Furthermore, new tracks, and accordingly also new data files 6, may be generated from a plurality of data files 6 for different tracks, for example, by joining two tracks at matching geographic positions. A track can also be shortened by cutting off a certain part. This is preferably carried out in the context of offline data preparation.

Such a data file 6 of a virtual track A*-B* with reference to geo-coordinates P can now be used on a test bench 20, e.g. a chassis test bench for a vehicle, a powertrain test bench or an engine test bench, during a test run for a virtual vehicle 1* or a component (power train, internal combustion engine, transmission, or the like) thereof, in various ways, as will be described in further detail below with reference to FIG. 2. It should be noted that the test bench 20 is intended to mean systems with which the unit under test 21 (the unit that is supposed to be tested), e.g. a vehicle, power train, battery, internal combustion motor, or the like, is actually provided on a test bench and is actually operated, as well as systems where the unit under test 21 is not even real itself but is simulated on the basis of appropriate simulation models 27.

Primarily, such a recorded, or processed, test drive with a vehicle 1, i.e. a virtual track A*-B*, is used to control a test run of a virtual vehicle 1* on a test bench 20, as shall be described in greater detail below with reference to FIG. 2.

“Virtual” vehicle 1* because the vehicle is simulated either in part or completely for the test run, and is set up in part (in the form of the unit under test 21) on the test bench. The virtual vehicle 1* also need not to conform to the vehicle 1 with which the real track AB was driven. The virtual vehicle 1 comprises different components, such as a battery, internal combustion engine, electric motor, transmission, suspension, tires, steering system, brakes, and the like, which may be simulated on the basis of suitable simulations models 27, e.g. in the test bench control unit 25, or may actually be present on the test bench 20 as the unit under test 21. For example, the battery may actually be provided as the unit under test 21, in which case test bench is called a battery-in-the-loop (more generally, hardware-in-the-loop). The test run is then applied on the virtual vehicle 1*, which comprises virtual and optionally real components.

A “test run” is intended to refer to subjecting the virtual vehicle 1*, having a real or virtual unit under test 21, on a test bench 20, e.g. a chassis test bench, a powertrain test bench or an engine test bench, to a chronological sequence of different driving conditions, and thereby detecting and, where necessary, assessing certain desired measurement variables of the virtual vehicle 1* (or more precisely of the unit under test 21). For this purpose, a load machine 22 is typically provided, in order to simulate different load conditions, e.g. slopes, acceleration, electric power, electric current, and the like, of the unit under test 21 and thus to load the unit under test 21. If the unit under test 21 itself exists only virtually, then it shall be readily understood that the load machine 22 may also be omitted or also be simulated.

Similarly, conditioning systems 23 may be provided on the test bench 20, in order to condition certain media, such as oil, water, air, or the like, for a test run. Climate systems 24 may also be provided on the test bench 20 in order to simulate certain environmental conditions, such as temperature, pressure, weather, or the like, on the test bench 20. The recorded virtual track A*-B* is traced through the test run. Provided for this purpose is a test bench control unit 25 that controls all of the components of the test bench 20 in accordance with the test run.

For this purpose, the test bench control unit 25 receives the data file 6 for a virtual track A*-B*, in which the test run is stored with reference to geo-coordinates P, i.e. in terms of geographic coordinates, and is able to generate a setpoint value for the components of the test bench 20 therefrom in real-time. The location data, such as the longitude LG, the latitude BG and the altitude H, as well as the dynamic data of the vehicle 1, such as speed, acceleration and inclination, are then converted into setpoint values for the unit under test 21 and the load machine(s) 22, or for other required actuators on the test bench 20.

For this purpose, the speed v of the virtual vehicle 1*, which is stored in the data file 6 of the virtual track A*-B*, can be used along the virtual track A*-B* over the time axis in order to control the unit under test 21. The speed v can thus also define the time that must elapse between two geo-coordinates P. Alternatively, also the stored time can be used along with the distance between two gee-coordinates P in order to calculate a speed. Stored data, such as the 3D orientation of the vehicle 1 and topography of the track (slopes, gradient, inclines) can be used to control the load machine 22 or simulate a load condition for the unit under test 21. A virtual or real driver is then “set” in the virtual vehicle 1* for the test run.

In the case of a real driver, the driver controls the virtual vehicle 1* in accordance with the specifications (topography, road signs, speed limits, traffic lights, events, and the like) of the virtual track A*-B* in the data file 6.

In the case of a virtual driver, an implemented driver model provides for the implementation of the specifications in the data file 6. The driver model may then comprise a course and speed planning, e.g. in order to specify how to drive curves, how to accelerate or brake, how to react to the traffic on the track A*-B*, how to react to events (e.g., bursting tires, ice on the roadway, elk on the roadway, or the like) and so forth, and may also comprise a vehicle control, e.g. in order to operate the gas pedal, brakes, clutch, gear, handbrake, steering wheel, ignition, and the like. It may also be possible to parameterize the driver model in the driving characteristics thereof, such as to be defensive, aggressive, normal, or economical. Then, in accordance with the driver model and the virtual track A*-B*, the virtual driver provides for the implementation of the route and speed specified for the virtual vehicle 1*, e.g. by operating the gas pedal or brake pedal, shifting the gear up or down, steering, and so forth.

In this manner, the virtual track A*-B* can be driven with the virtual vehicle 1* on the test bench 20 in real-time. The track is then no longer present as a one-dimensional path-time diagram, as in the known prior art, but rather as a three-dimensional trajectory in the form of geo-coordinates P with the data D added thereto.

The data D on the vehicle surroundings stored in the data file 6, such as the ambient temperature, pressure, weather, and the like can be passed to the climate system 24 as setpoints. The data D stored in the data file 6 that reflects the operating behavior of the vehicle, such as oil pressure, oil temperature, water temperature, and the like, can be passed to the conditioning system 23 as setpoints.

Singularities in the virtual track A*-B*, e.g. a bridge crossing, an intersection, or a motorway entrance or exit, may be solved by suitable processing logics, e.g. by comparing the altitude data or taking into account the direction of movement of the virtual vehicle 1*, which can be determined from the geo-coordinates P or can be directly stored in the data file 6.

To take into account the inertia of certain components of the test bench 20, e.g. a climate system 24 or a conditioning system 23, it is also conceivable that the test bench control unit 25 may look ahead in the data file 6, i.e. by 10 seconds in time or by 100 m, in order to make any necessary setpoint changes for these components in time, in a kind of pilot control.

Measured data M of the virtual vehicle 1* that is detected during the test run, such as indicating data of the combustion of an internal combustion engine, fuel consumption values, emissions values, or the like, is then likewise stored in a data storage unit 4 with reference to the respective geo-coordinate P. To detect measured data M, corresponding measurement sensors 28 may be provided on real components of the virtual vehicle, i.e. on the unit under test 21, or calculated values from a simulation model 27 of a virtual vehicle component may also be used as the measured data M. The storage may take place in the data file 6 or in a separate measured data file 7. Data D in the data file 6 and measured data M are clearly related via the geo-coordinates P. Measured data M on different test runs can thus also be directly compared via the geo-coordinates P.

It shall be readily understood that any variation on the test bench 20 is also conceivable. For example, a recorded test drive (virtual track A*-B*) could be virtually traced on the test bench 20 with a different driver or a plurality of drivers having different driver behaviors, or different weather could be simulated. It would also be possible to virtually trace the recorded test run on the test bench 20 in sections or in its entirety with a different speed of the vehicle 1. The operating states of the vehicle may also be deliberately altered in order to test certain situations, such as the state of charge of the traction battery of a hybrid vehicle. These alterations may be produced by adapting the data file 6. These variations are, however, also possible in real-time, such as by engaging a test bench driver via an I/O interface 26 in the test run, e.g. by manually accelerating or altering of certain parameters.

The stored video file V may be used, for example, to play back and to depict on a screen the video of the real drive, and thus of the track A-B, at least in part for a test run that is based on the driven track A-B. For this purpose, the playback of the video V is synchronized with the respective geo-coordinate P via the stored video reference F. This makes it possible that the video frame f_{P} that matches the geo-coordinate P, i.e. the video frame f_{P} that is closest to the respective current geo-coordinate P of the virtual vehicle 1*, no matter how or in what sequence the virtual track A*-B* is virtually traced. The video V may then be synchronized with the test run in a very simple manner via the geo-coordinate P. Between two stored geographic locations, the playback of the video simply continues, for example, by interpolation on the basis of the stored times or speeds between two geo-coordinates P. Alternatively, as well, a video control may be implemented, which controls the playback speed of the video between two geo-coordinates P. The video frames between two geo-coordinates P are therefore played back in proper time and synchronized with the geo-coordinate P. If, for example, a test bench driver manually accelerates, which causes the virtual vehicle 1* to move faster through the virtual world, then the video V is also played back faster, synchronously thereto. No matter how the test run is carried out, be it faster, slower, with stops, or the like, the correct part of the video V is always played back due to the synchronization via the geo-coordinate P.

If a plurality of videos V exist in the video storage unit for a certain geo-coordinate P, then a selection of choices for a certain video V may also be offered to the test bench driver, e.g. from the test bench control unit 25 via the I/O interface 26. During a virtual drive along the virtual track A*-B*, a video search engine running in the background, continuously searches in the existing video files for videos V that were filmed in the region of the respective geo-coordinate P and offers these for the test bench driver to select from. This eliminates the cumbersome manual search in the video files, which are extensive. This can be done not only at the start of the virtual drive, but also continuously during the drive.

The video search engine also ensures that a plurality of separately-stored videos V for a virtual track A*-B* are started, stopped, combined, or cut off at the correct place (geo-coordinate P), preferably in an automated manner.

In the same manner, of course, recorded audio data and all other measurement channels (data D or measured data M of the vehicle 1*, the driver, and/or the surroundings) may also be managed and played, recorded, or displayed during the test run on the test bench 20.

A video V can, however, also be used as a specification for a test bench driver, who would then have the video V played back and manually traces the track that is played back thereon with suitable control devices, such as a gas and brake pedal.

For a track A*-B* that is to be driven virtually, data D or measured data M from measured data files 7 of other recorded drives may also be displayed. For this purpose, data files 6 or measured data files 7 in the data storage unit 4 that were stored for the same geo-coordinate P are retrieved. This makes it possible to even directly compare data D or measured data M that is for the same geo-coordinate P but from different test drives. This may be useful, for example, for calibrating the control units of the vehicle 1, because the impact of changes, for example to the emissions of the vehicle 1, can be directly tracked in this manner.

Data files 6 or measured data files 7 generated in this manner may also, of course, be analyzed offline in the context of post-processing. For example, certain comparisons can be made by filtering and displaying data D or measured data M in accordance with certain specifications, e.g. driving at a speed of 50 km/h in third gear. It would alternatively be possible to analyze the consumption of fuel or emissions of all of the vehicles on a certain track A-B.

It shall be readily understood that all of the data D, measured data M, or videos V stored for a geo-coordinate P can also very easily be displayed.

In addition, other metadata can also be stored with reference to the geo-coordinates P along the virtual track A*-B*, e.g. photos, algorithms for the wiring of traffic lights, traffic density, and the like.

1. A method for carrying out a test run of a virtual vehicle (1*) on a test bench (20), the method comprising the following steps:
reading a virtual track (A*-B*) from a data storage unit (4), wherein the virtual track (A*-B*) is stored as a sequence of geo-coordinates (P) and corresponding data (D) of the vehicle (1*), a driver and/or surroundings of the vehicle (1*), the data (D) being related to the geo-coordinate (P);
using the data (D) that is stored in reference to the geo-coordinates (P) in order to carry out the test run of the virtual vehicle (1*); and
detecting measured data (M) of the virtual vehicle (1*) during the test run and storing the detected measured data (M) with reference to the geo-coordinates (P).

2. The method according to claim 1, wherein a real track (A-B) is driven with a real vehicle (1), and the geo-coordinates (P) and data (D) of the vehicle (1), the driver and/or the surroundings of the vehicle (1) are detected during the drive along the real track (A-B) and stored as the virtual track (A*-B*) with reference to the geo-coordinates (P).

3. The method according to claim 1, wherein the geo-coordinates (P) of a track (A-B) are detected from digital 3D map data and stored as the virtual track (A*-B*), and data (D) of the vehicle (1*), the driver and/or the surroundings of the vehicle (1*) is added.

4. The method according to claim 1, wherein a sequence of stored geo-coordinates (P) is driven as test run.

5. The method according to claim 1, wherein a stored speed (v) or a stored time is used in order to control the virtual vehicle (1*) in the test run.

6. The method according to claim 1, wherein the virtual vehicle (1*) for carrying out the test run is controlled by a virtual driver on the basis of a driver model.

7. The method according to claim 1, wherein the virtual vehicle (1*) for carrying out the test run is controlled by a real driver.

8. The method according to claim 1, wherein video data about the test track (A-B) is additionally detected in the form of a sequence of video frames (f) and the video frame (fP) that corresponds to the respective gars-coordinate (P) being determined and displayed during the test run on the test bench (20).

9. The method according to claim 1, wherein audio data about the test track (A-B) is additionally detected and stored with reference to the geo-coordinate (P) and the audio data that corresponds to the respective geo-coordinate (P) being played back during the test run on the test bench (20).

10. The method according to claim 1, wherein available data (D) or available measured data (M) for the respective geo-coordinate (P) is retrieved and displayed during the test run.

11. The method according to claim 1, wherein data (D) or measured data (M) is searched, identified, and compared via its geo-coordinate (P) in the post-processing of the test run.
